(19) United States
(12) Patent Application Publication
(10) Pub. No.: US 2009/0308218 A1
(43) Pub. Date: Dec. 17, 2009

(54) ELECTRIC HAND-HELD POWER TOOL SYSTEM

(76) Inventors: Thomas Raff, Dettenhausen (DE); Juergen Gairing, Stuttgart (DE); Steffen Weber, Filderstadt (DE)

Correspondence Address: MICHAEL J. STRIKER, 103 EAST NECK ROAD, HUNTINGTON, NY, 11743, US

(21) Appl. No.: 12/376,061

(22) PCT Filed: Mar. 19, 2008
(86) PCT No.: PCT/EP2008/053268

§ 371 Date: Feb. 2, 2009

(30) Foreign Application Priority Data
May 7, 2007 (DE) 10 2007 021 334.6

(51) Int. Cl. B23Q 9/00

(52) U.S. Cl. 83/745; 30/289

(57) ABSTRACT

The invention relates to a hand-held machine tool arrangement, particularly a hand-held circular saw arrangement, a surface milling cutter, or a saber saw arrangement, or the like, having a hand-held machine tool and at least one guide rail which can be seated or clamped to a workpiece to be processed, and having a longitudinal guide for a longitudinal displacement of the hand-held machine tool on the guide rail. It is proposed that the guide rail (1) has at least one recess open to the edge, in which there is a ribbing (20).

The present invention relates to an electric hand-held power tool system, in particular an electric circular saw system, an electric router system, an electric jigsaw system, or the like, according to the preamble of claim 1.

### BACKGROUND INFORMATION

Regarding electric hand-held power tool systems, in particular those that include an electric circular saw, an electric router, an electric jigsaw, or similar electric hand-held power tools, it is known from the prior art to provide these devices with a guide rail for making long, straight cuts, the guide rail providing longitudinal guidance for a longitudinal displacement of the electric hand-held power tool to make a straight cut. For example, DE 10 2004 017 420 A1 describes an electric hand-held power tool, namely a hand-held circular saw in particular, that includes a guide rail which may be placed on the workpiece to be machined, in the case of which a T-shaped longitudinal groove is formed in a solid guide rail; a slot element which is attached to the electric hand-held power tool engages in the T-shaped longitudinal groove. The disadvantage is that the guide rail must be relative solid in design. As a result, and in particular due to its weight and the solid design, it is difficult to handle. Moreover, it is suitable for use only with electric hand-held power tools that accommodate or include the related slot element. DE 102 51 578 B3 describes a guide rail for hand-held power tools, which includes stop elements which form effective stops for the carrier plate in the longitudinal direction and in the vertical direction. This is also solid and single-pieced in design. This design is also a disadvantage, in particular, since it is heavy and difficult to handle, in particular in the longitudinal direction.

### DISCLOSURE OF THE INVENTION

In contrast, and according to the present invention, an electric hand-held power tool system is provided, in particular an electric circular saw system, an electric router system, an electric jigsaw system, or the like, which includes an electric hand-held power tool and at least one guide rail which may be placed or clamped onto a workpiece to be machined, and including a longitudinal guide for the longitudinal displacement of the hand-held power tool on the guide rail. It is provided that the guide rail includes at least one open-ended recess in which ribbing is located. In contrast to the prior art, the guide rail is therefore not produced as a solid component which is created in particular using a solid material, e.g. via milling, but rather is produced as a guide rail having an open-ended recess. Ribbing is provided to increase stability. Considerably less material is used as a result, thereby resulting in a guide rail having a much lighter weight and greatly improved handling.

According to a further embodiment, it is provided that the recess is located on the back side of the guide rail. The guide rail may therefore be considered to be a longitudinal, rectangular body which is designed—in the broadest sense—in the shape of a boat, the recess (that is, the “opening” of the boat) being located on the back side of the guide rail. The “back side” refers to the region of the guide rail that is placed on the workpiece. The ribbing is preferably situated inside the recess, and, in conjunction with side walls of the guide rail, provides a connection stiffness of the guide rail that is appropriate for the intended use.

In a further, particularly preferred embodiment, the ribbing includes ribs, at least one of which, in particular, is designed as a longitudinal rib and/or a transverse rib and/or a diagonal rib. A longitudinal rib is a rib that follows the longitudinal extension of the guide rail. A tranverse rib is a rib that is oriented essentially transversely, and, in particular, at a right angle to a longitudinal rib and/or the longitudinal extension, and a diagonal rib is a rib that extends between corners of the guide rail or between corners that are formed by longitudinal ribs and transverse ribs, i.e. that extend essentially at a 45-degree angle to longitudinal ribs and/or transverse ribs. It is also possible, in particular, to provide and combine a plurality of similar or different ribs in the recess in order to attain the desired connection stiffness for the particular application and/or the particular length of the guide rail.

According to a particularly preferred embodiment, a plurality of ribs is provided, the ribs being connected to one another at intersection points. The ribs described above are therefore combined, at least in certain regions, thereby resulting, e.g. in longitudinal ribs and transverse ribs, or transverse ribs and diagonal ribs, or longitudinal ribs, transverse ribs, and diagonal ribs, these ribs being connected to one another at intersection points, i.e. transitioning into one another as single pieces in particular, but at least being connected to one another in a form-fit and/or non-positive manner. Using a relatively small amount of effort and minimal rib strength, it is therefore possible to attain excellent connecting stiffness across the entire extension of the guide rail.

In a further embodiment, at least two guide rails are provided, which are connectable to one another along the length using insertion means. The disadvantage of guide rails known from the prior art is that they are designed as a single piece across their entire length which is usually considerable. As a result, they must be transported separately from the electric hand-held power tool with which they are to be used. According to the present invention, however, at least two guide rails are provided which have a length, e.g. that allows them to be transported together with the electric hand-held power tool with which they are to be used, in one packaging unit, e.g. a machine case. The guide rails may be connected to one another across their length using insertion means in order to attain a guide-rail length that is required to perform work and longitudinal cuts. Insertion means are therefore provided which enable a plurality of guide rails to be connected to one another. It is also provided in particular that the guide rail may be extended as necessary, and therefore does not have a design-related maximum length.

In a preferred embodiment, the insertion means are designed as at least one projection and as at least one insertion recess which receives the projection. A projection is therefore formed at one end of the guide rail, which engages, as the insertion means, in at least one insertion recess in another guide rail. A form-fit/non-positive connection is thereby established, thereby preventing the guide rails from becoming accidentally detached from one another. The longitudinal extension is continued linearly and without interruption, thereby enabling the electric hand-held power tool to slide easily from one guide rail to the next and to be guided without interruption.

In a preferred embodiment, at least one snap-in connection is provided, or at least one insertion means forms a snap-in connection. A snap-in connection is any connection in which a connecting element engages in another in a manner such that it engages, e.g., in the manner of a hook, with a projection in a corresponding recess. To release the snap-in connection, the hook or similar means must be actuated, e.g. a part of the snap-in connection, in particular the hook, must be bent backward or away from the recess.

In a further, preferred embodiment, the projection is located on an end face of the guide rail, and the insertion recess is located on the other side of the guide rail. In this manner, guide rails may be situated next to one another or extended in any manner without any design-related obstacles preventing them from being extended.

In a further embodiment it is provided that the longitudinal sides of the guide rail are provided with an anti-splintering device. It is provided in particular that the anti-splintering device is situated on both longitudinal sides of the guide rail, and, in fact, preferably symmetrically to the guide, which is preferably formed by a guide rib. It is therefore possible to use the electric hand-held power tool system with the cutting region of the electric hand-held power tool on either side. In this manner, in particular, it is possible to use one longitudinal side of the guide rail to make straight cuts, e.g. using an electric circular saw, the anti-splintering device being set on this longitudinal side to the distance between the saw blade and a longitudinal wall of the guide rail, in particular by sawing away or making an initial sawing incision the first time the anti-splintering device is used, thereby ensuring that the anti-splintering device is always positioned very well and with excellent fit. The other longitudinal side is used to make diagonal cuts, the anti-splintering device being set to the distance between the saw blade, which has been swiveled accordingly, and the side wall of the guide rail. The anti-splintering device may be composed, e.g. of rubber or another elastic material, and it is designed in particular as a detachable, replaceable part. If the guide rib is situated asymmetrically against or next to the guide rail (i.e. not longitudinally in the center), the distance between the non-swiveled saw blade and the longitudinal sides of the guide rail is changed simply by turning the guide rail (i.e. to use one longitudinal side and then the other). This is advantageous (for making miter cuts) in particular with the saw blade swiveled since the initial (non-swiveled), greater distance between the saw blade and the guide rail compensates, to a certain extent, for the saw blade being approached when it is swiveled; the penetration point of the saw blade on the top side of the item to be cut is also adjacent to the guide rail, thereby resulting in good anti-splintering protection. This also prevents the guide rail from being accidentally sawed into.

In a further embodiment, an anti-slip overlay is provided on the underside of the rail. It is preferably formed of an elastic material, e.g. rubber or an elastomer, and ensures that the guide rail does not slide away when it is not mechanically clamped to the workpiece. The anti-slip overlay may cover, e.g. the ribbing more or less completely, or it may be provided as a flat overlap in sections. Given that the action of force usually takes place in the longitudinal direction of the guide rail, in particular when guiding the electric hand-held power tool, when rubber or an elastomer is used, excellent adhesion results in the longitudinal direction, and the guide rail is prevented from slipping.

In a further preferred embodiment, the guide rail is composed of a plastic. As a result, the guide rail is lightweight, and it is easy and cost-effective to manufacture.

Further advantageous embodiments result from the subclaims and combinations thereof.

### BRIEF DESCRIPTION OF THE DRAWING

The present invention is explained below in greater detail with reference to an embodiment and to the figures.

FIG. 1 shows a guide rail for an electric hand-held power tool, in a top view;

FIG. 2 shows the same guide rail from its underside, and

FIG. 3 shows two guide rails being attached via insertion, as viewed from the underside.

### EMBODIMENT(S) OF THE INVENTION

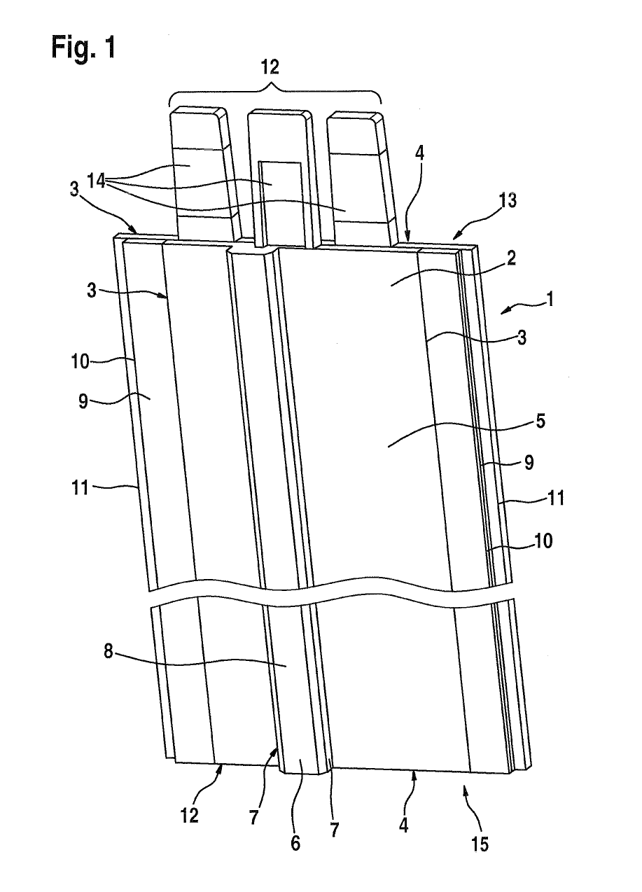

FIG. 1 shows a guide rail 1 for an electric hand-held power tool (not depicted) for an electric hand-held power tool system (not depicted). Guide rail 1 is composed of a guide rail body 2 which Includes opposing longitudinal sides 3 and opposing end faces 4 which are situated at right angles to longitudinal sides 3, at their ends. As viewed from above, the guide rail has a rectangular outline; a guide rail top side 5 is located between the longitudinal sides and the end faces. A guide rib 6 which is raised and is parallel to the longitudinal sides, and which is positioned non-equidistantly from longitudinal sides 3 is located on guide rail top side 5. Guide rib 6 has a cross section which is essentially rectangular, and it is continuous in the longitudinal direction of guide rail 1 from one end face 4 to opposite end face 4. Guide rib 6 includes rib lateral walls 7 which are parallel to longitudinal sides 4, and it includes a guide rib top side 8 which is at least essentially parallel to guide rail top side 5. The electric hand-held power tool (not depicted) is placed on guide rail top side 5. Guide rib 6 extends in recesses having a matching shape, or in at least one recess having a matching shape, the recess preferably extending in the longitudinal direction on the electric hand-held power tool. The electric hand-held power tool (not depicted) may be displaced longitudinally in this manner on guide rail 1 in engagement with guide rib 6. Guide rib 6 prevents the electric hand-held power tool (not shown) from deviating to one side, i.e. it prevents the electric hand-held power tool from moving transversely to the axial/longitudinal direction of guide rail 1, guide rib 6 being engaged in the similarly-shaped recess of the electric hand-held power tool. An anti-splintering device 9 is located on each longitudinal side 3 of guide rail 1. It extends parallel to longitudinal side 3 from one end face 4 to opposite end face 4. Anti-splintering device 9 is preferably composed of an elastomer or rubber 10 which has the appropriate elasticity for the particular application. When guide rail 1 is used for the first time, for example, with the electric hand-held power tool (not depicted), e.g. an electric portable circular saw, anti-splintering device 9 is sawed into or sawed off, at least in sections, namely in its longitudinal direction (namely on longitudinal edge 11 of anti-splintering device 9 further from longitudinal side 3 of guide rail). In this manner, a reliable and essentially flush placement of the anti-splintering device against the circular saw blade is attained, so that, when individual saw teeth of the circular saw blade emerge from the workpiece (not depicted) to be machined, chips are prevented from breaking away from the workpiece via the placement of anti-splintering device 9 on the workpiece. End faces 4 of guide rail 1 include insertion means 12 which are used to connect guide rail 1 to another (not depicted) guide rail 1. Insertion means 12 are designed as a projection 14 on one end face 13, and, on second end face 15, insertion means 12 are designed as an insertion recess 16 for receiving projection 14 belonging to another, second guide rail 1.

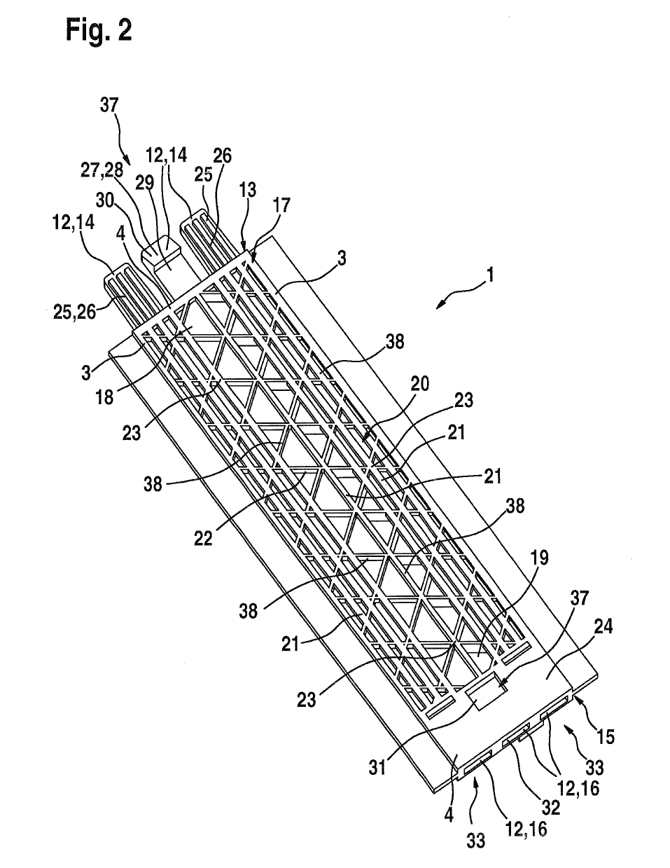

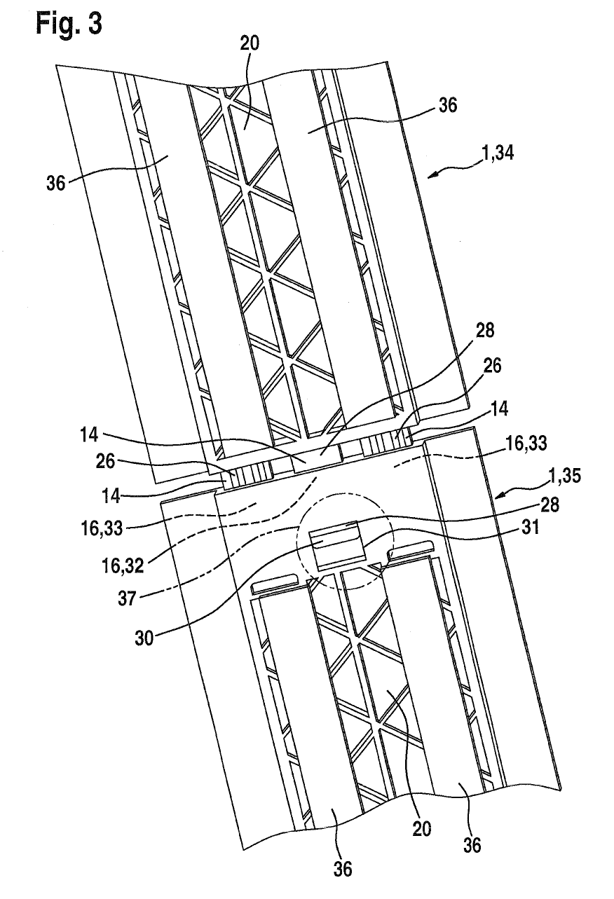

FIG. 2 shows guide rail 1 as viewed from its guide rail underside 17. An open-ended recess 19 which gives guide rail 1 the basic appearance of being an open, flat cover or an open, flat, right-angled shell is located between longitudinal sides 3 and end faces 4 of guide rail 1, and guide rail top side 5 which connects the two (shown only from underside 18 due to the perspective); together they form guide rail body 2 of guide rail 1. Ribbing 20 is situated in open-ended recess 19, extending from longitudinal side 3 to opposite longitudinal side 3, and from end face 4 to opposite end face 4. Ribbing 20 is composed of ribs 38, i.e. longitudinal ribs 21 and diagonal ribs 22. Longitudinal ribs 21 extend from one end face 4 to opposite end face 4, while the diagonal ribs are situated diagonally thereto, e.g. at an angle of 45°. Longitudinal ribs 21 and diagonal ribs 22 are connected to one another at intersection points 23. Every intersection of a longitudinal rib 21 with a diagonal rib 22 forms an intersection point 23 which connects the two. In this manner, it is attained that a force that acts on guide rail 1 and, e.g. changes geometry, is absorbed via diagonal ribs 22 and longitudinal ribs 21 which are connected to one another via intersection points 23, and which are connected to longitudinal sides 3 and end faces 4. This results in a very high torsional stiffness of guide rail 1. Ribbing 20, together with guide rail body 2, is preferably manufactured using an injection-molding procedure or a similar, suitable manufacturing method, guide rail 1 preferably being made of a plastic 24. Three projections 14 are formed as insertion means 12 on one first end face 13 of guide rail 1, while three insertion recesses 16, as insertion means 12, are formed on second end face 15. Of projections 14, the two projections 25 situated on the outside are designed as guide projection 26, while a center projection 27 is designed as snap-in hook 28. For this purpose, it includes a hook projection 30 on its snap-in hook underside 29, which engages in a hook recess 31—having a matching shape—in a central insertion recess 32 (i.e. the middle of the three insertion recesses 16) on second end face 15. Snap-in hook 28 and hook recess 31 therefore form a snap-in connection 37 The two projections 25 which are located on the outside and form guide projections 26 engage in outer insertion recesses 33 on second end face 15 and are used for dimensional stabilization and guidance of insertion means 12. FIG. 3 shows two guide rails 1, i.e. a first guide rail 34 and a second guide rail 35 at the instant when the connection is established. For this purpose, projections 14 of first guide rail 34 are slid into insertion recesses 16 in second guide rail 35, although the connection is not yet completely formed. Guide projections 26 engage in outer insertion recesses 33 in second guide rail 35, while snap-in hook 28 engages in central insertion recess 32 in second guide rail 35 to form snap-in connection 37. Hook projection 30 will snap completely into hook recess 31 in second guide rail 35 when first guide rail 34 comes to rest completely against second guide rail 35, thereby detachably connecting the two guide rails 1 to one another. The connection is released by pressing hook projection 30 inward inside hook recess 31, thereby eliminating its detent effect so that the two guide rails 1 may be pulled apart and separated from one another.

To prevent guide rail 1 from slipping on a workpiece to be machined, ribbing 20 on both guide rails 1 is covered with anti-slip overlays 36, in sections, which extend in the longitudinal direction on guide rail 1 on the ribbing. Anti-slip overlay 36 is preferably composed of a soft elastomer, e.g. a soft rubber.

The present invention is not limited to electric hand-held power tools, and it intended for use for hand-held power tools having any type of drive.

What is claimed is:

1. A hand-held power tool system, in particular a portable circular saw system, a router system, a jigsaw system, or the like, which includes a hand-held power tool and at least one guide rail which may be placed or clamped onto a workpiece to be machined, and including a longitudinal guide for the longitudinal displacement of the hand-held power tool on the guide rail,
wherein
the guide rail (1 ) includes at least one open-ended recess (19) in which ribbing (20) is located.

2. The hand-held power tool system as recited in claim 1,
wherein
the recess (19) is located on the back side of the guide rail (1).

3. The hand-held power tool system as recited in claim 1,
wherein
the ribbing (20) includes ribs (38), at least one of which, in particular, is designed as a longitudinal rib (21) and/or a transverse rib and/or a diagonal rib (22).

4. The hand-held power tool system as recited in claim 1,
wherein
several ribs (38) are provided which are connected to one another via intersection points (23).

5. The hand-held power tool system as recited in claim 1,
wherein
at least two guide rails (1) are provided which are connected to one another longitudinally using insertion means (12).

6. The hand-held power tool system as recited in claim 1,
wherein
the insertion means (12) are designed as at least one projection (14) and as at least one insertion recess (16) which receives the projection (14).

7. The hand-held power tool system as recited in claim 1,
wherein
at least one snap-in connection (37) is provided, or wherein at least one insertion means (12) forms a snap-in connection.

8. The hand-held power tool system as recited in claim 1,
wherein
the projection (14) is located on an end face (4) of the guide rail (1), and the insertion recess (16) is located on the other side of the guide rail (1).

9. The hand-held power tool system as recited in claim 1,
wherein
the longitudinal sides (3) of the guide rail (1) are equipped with an anti-splintering device (9).

10. The hand-held power tool system as recited in claim 1,
wherein
an anti-slip overlay (36) is located on the underside of the guide rail.

11. The hand-held power tool system as recited in claim 1,
wherein
the guide rail (1) is composed of a plastic (24).
